(19) United States
(12) Patent Application Publication
(10) Pub. No.: US 2017/0266859 A1
(43) Pub. Date: Sep. 21, 2017

(54) BLOCK MOLD

(71) Applicant: SABIC GLOBAL TECHNOLOGIES B.V., Bergen op Zoom (NL)

(72) Inventors: Peter Neerincx, Oisterwijk (NL); Ruud Heerkens, Bergen op Zoom (NL)

(73) Assignee: Sabic Global Technologies B.V., Bergen OP Zoom (NL)

(21) Appl. No.: 15/531,883

(22) PCT Filed: Dec. 1, 2015
(86) PCT No.: PCT/IB2015/059265

§ 371 Date: May 31, 2017

Related U.S. Application Data
(60) Provisional application No. 62/085,809, filed on Dec. 1, 2014.

(51) Int. Cl. B29C 45/16; B29C 71/02; B29C 45/56

(52) U.S. Cl. CPC B29C 45/1635; B29C 45/1679; B29C 45/561; B29C 71/02; B29C 2045/1637; B29C 2045/563; B29C 2045/564; B29K 2071/00

(57) ABSTRACT

A molding system (10) for fabricating a part comprises a first mold section (12) defining a first mold cavity (14), a first insert (16) slidable to a plurality of positions relative to the first mold cavity (14) to adjust a dimension of the mold cavity, a second mold section (20) to be disposed adjacent to the first mold section (14) to at least partially enclose the first mold cavity (14), a molding material conduit (26) to be disposed in fluid communication with the first mold cavity (14), and a positioning mechanism (18) configured to move the first insert (16) to the plurality of positions relative the first mold cavity (14).

### CROSS-REFERENCE TO RELATED APPLICATION

This application claims priority to U.S. Provisional Application No. 62/085,809, filed on Dec. 1, 2014, the entire disclosure of which is incorporated herein by reference.

### BACKGROUND

Rapid prototyping can involve the fabrication of physical parts using three-dimensional (3D) computer-assisted design (CAD) data. Currently, a primary method of rapid prototyping is 3D printing, such as via selective laser sintering. Not all materials are suitable or compatible with selective laser sintering, however.

### SUMMARY

The present disclosure describes a molding system and method for fabricating a thick-walled block that can be used for rapid prototyping via standard cutting or machining techniques.

In an example, the present disclosure describes a molding system for fabricating a block of material, the molding system comprising a first mold section partially enclosing a mold cavity, a first insert slidable along the mold cavity in order to change the size of the mold cavity, a second mold section positionable adjacent to the first mold section to enclose the mold cavity, a material conduit for feeding molding material into the mold cavity, wherein the molding material can solidify in the mold cavity, and a mechanism configured to position the first insert at a plurality of positions along the mold cavity.

In another example, the present disclosure describes a method of fabricating a block of material, the method comprising positioning a first mold section adjacent to a second mold section to enclose a mold cavity therebetween, positioning a slidable insert at a first position within the mold cavity to provide a first space having a predetermined thickness at a front end of the mold cavity, injecting molten material into the first space of the mold cavity, allowing the molten material to set to form a first layer, moving the slidable insert to a second position within the mold cavity to provide a second space between the first layer and the front end of the mold cavity, injecting molten material into the second space of the mold cavity, and allowing the molten material to set to form a second layer, the second layer being mechanically and chemically coupled to the first layer to form a block.

### BRIEF DESCRIPTION OF THE FIGURES

FIG. 1 is a cross-sectional side view of an example molding system for fabricating a thick-walled block that that can be used for rapid prototyping.

FIGS. 2A-2I are cross-sectional side views of another example molding system showing steps of an example method of fabricating a block by forming a plurality of layers.

FIGS. 3A and 3B show cross-sectional side views of another example molding system for fabricating a thick-walled block having an alternative example of an insert positioning mechanism.

FIGS. 4A and 4B show example methods of thermally conditioning a molded block to prevent or minimizing cracking or other damage due to shrinking during cooling.

### DETAILED DESCRIPTION

In the following Detailed Description, reference is made to the accompanying drawings which form a part hereof. The drawings show, by way of illustration, specific examples in which the present molding systems and methods can be practiced. These examples are described in sufficient detail to enable those skilled in the art to practice, and it is to be understood that other embodiments can be utilized and that structural changes can be made without departing from the scope of the present disclosure. Terms indicating direction, such as front, rear, left, right, up, and down, are generally used only for the purpose of illustration or clarification and are not intended to be limiting. The following Detailed Description is not to be taken in a limiting sense, and the scope of the present disclosure is defined by the appended claims and their equivalents.

As noted above, for materials that cannot be worked with 3D printing techniques, such as selective laser sintering, rapid prototyping can be achieved with standard cutting or machining techniques, such as milling and turning of a pre-made block of material. For some materials, however, standard cutting or milling techniques are not cost effective due to the cost of producing the pre-made block via traditional extrusion techniques. For example, forming blocks of polycarbonate or polyetherimide (PEI, such as ULTEM resin, sold by SABIC Innovative Plastics of Pittsfield, Mass.) can be cost prohibitive due to the extremely high startup costs associated with setting up an extrusion line to produce pre-made blocks.

This disclosure describes molding systems and methods for fabricating a thick-walled block that can be used for rapid prototyping via standard cutting or machining techniques. The molding system and method of the present disclosure can be used to form blocks of a material that are not suitable for 3D printing via selective laser sintering (SLS) or that cannot be cost-effectively fabricated using typical extrusion techniques. Examples of materials for which the molding systems and methods of the present disclosure may be particularly useful include, but are not limited to: polycarbonates, such as those commercially available under the trade name LEXAN from the Innovative Plastics division of SABIC, Pittsfield, Mass., USA; polyetherimides (PEI), such as those commercially available under the trade name ULTEM from the Innovative Plastics division of SABIC; polymethy methacrylate polymers (PMMA); polyethylene terephthalate polymers (PET); polybutylene terephthalate polymers (PBT), such as those commercially available under the trade name VALOX from the Innovative Plastics division of SABIC; polystyrene polymers; and acrylonitrile-butadiene-styrene polymers (ABS), such as those commercially available under the trade name CYCOLAC from the Innovative Plastics division of SABIC.

The molding system and method described herein can result in an over-molding process that can decrease overall cooling time compared to single-layer injection molding of the same material. The cooling time of a molding material can be subject to equation [1]:

t∝2n×d² [1]

where t is the total cooling time required for a block comprising one or more layers, n is the number of layers in the block, and d is the thickness of each layer. For example, if a block formed out of a particular material is formed as a single layer having a thickness of 50 millimeters (mm), the cooling time for that block may be 5000 seconds, or about 83 minutes. If a similar block is formed as 25 layers of the same material, with each layer having a thickness of 2 mm, then the total cooling time for the block can be reduced to only 200 seconds (about 3.33 minutes). As demonstrated through equation [1], optimization of cooling time can be relatively easy, namely: the layer thickness should be as thin as possible.

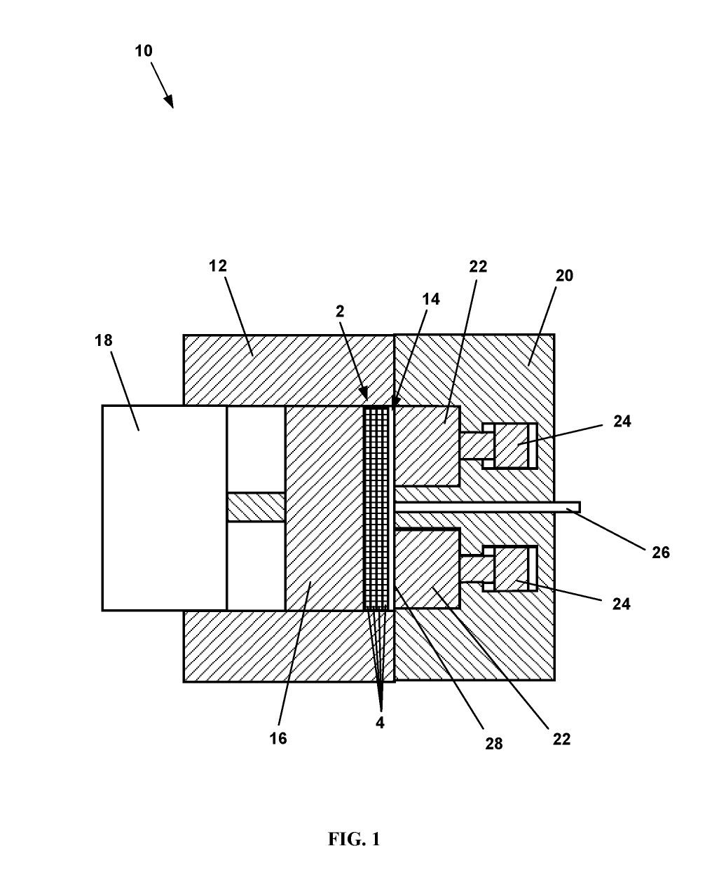

FIG. 1 is a cross-sectional view of a molding system 10 for fabricating a relatively thick block 2 made from a material that is difficult to easily and quickly mold in a single-layer block. The molding system 10 can be configured to form the block 2 as a plurality of layers 4 that can each be deposited sequentially and individually and allowed to cool to form the overall block 2. In the example shown in FIG. 1, the molding system 10 can include a first mold section 12, also referred to herein as a rear mold section 12, that defines a first mold cavity 14. A first insert 16, also referred to herein as a rear insert 16, can be positioned inside the mold cavity 14 and can be slidable in a forward and backward direction (e.g., left to right in FIG. 1) inside the mold cavity 14 to a plurality of positions relative to the rear mold section 12. The slidable rear insert 16 can move relative to the rear mold section 12 in order to change a size of the mold cavity 14 in the direction of movement of the rear insert 16 (e.g., left-to-right in FIG. 1). The molding system 10 can include a first positioning mechanism 18, also referred to herein as a rear insert positioning mechanism 18, configured to move the rear insert 16 back and forth in the direction of movement in order to control the size of the mold cavity 14.

The molding system 10 can also include a second mold section 20, also referred to herein as a front mold section 20. The front mold section 20 can define a second mold cavity (not shown) that can be disposed adjacent to the first mold cavity 14 to form an overall mold cavity. The front mold section 20 can be disposed adjacent to the rear mold section 12 in order to enclose the mold cavity 14. The molding system 10 can include one or more mechanisms (not shown) to compress the front mold section 20 against the rear mold section 12, or vice versa, to ensure that molten material injected into the mold cavity 14 is not able to pass between the rear mold section 12 and the front mold section 20. One or more second inserts 22, also referred to as one or more front inserts 22, can be included within the front mold section 20. The front inserts 22 can be configured to position the block 2 within the mold cavity 14, for example to ensure that the block 2 is spaced from a location where new molten material is introduced into the mold cavity 14 to form a new layer 4, as described in more detail below. One or more second positioning mechanisms 24, also referred to herein as front insert positioning mechanisms 24, can be included and configured to move the front inserts 22 back and forth relative to the front mold section 20.

A material conduit 26 can pass through one or more of the rear mold section 12, the rear insert 16, the rear insert positioning mechanism 18, the front mold section 20, one or more of the front inserts 22, or one or more of the front insert positioning mechanisms 24. As shown in the example of FIG. 1, the material conduit 26 can pass through the front mold section 20 to allow molten material to be deposited at a front end 28 of the mold cavity 14 during injection.

The rear insert positioning mechanism 18 can be configured to move the rear insert 16 to a plurality of positions along the mold cavity 14 relative to the rear mold section 12. Each of the plurality of positions along the mold cavity 14 can correspond to one of the plurality of layers 4 that form the block 2, for example with a first position placing a front surface of the rear insert 16 within the mold cavity 14 relative to the front end 28 of the front mold section 20 at a distance equal or approximately equal to a desired thickness of a first layer 4. Similarly, a second position can be spaced from the first position by a distance equal or approximately equal to a desired thickness of a second layer 4, and so on. As described in more detail below, the rear insert positioning mechanism 18 can be configured to position the rear insert 16 along a continuum of essentially an infinite number of positions between the front end 28 of the mold cavity 14 and a rear-most position so that the thickness of a particular layer 4 can be any thickness desired. Alternatively, the rear insert positioning mechanism 18 can be configured to position the rear insert 16 at each of a plurality of discrete positions within the mold cavity 14.

The rear insert positioning mechanism 18 and the front insert positioning mechanisms 24 are shown generically as blocks in FIG. 1. As will be appreciated by a person of skill in the art, the positioning mechanisms 18, 24 can comprise any mechanism capable of moving the inserts 16, 22 and the block 2. In an example, each insert positioning mechanism 18, 24 can comprise one or more control systems that are configured for automatic movement of one or more of the inserts 16, 22, for example according to a preprogrammed order of movement of the inserts 16, 22 and injection of molten material into the mold cavity 14 to form the layers 4 of the block 2.

It may also be desirable for the rear insert positioning mechanism 18 be able to withstand the force produced by molten material as it is injected into the mold cavity 14 via the material conduit 26, e.g., without allowing the rear insert 16 to move rearward (e.g., to the left in FIG. 1) and change the size of the mold cavity 14. As the molten material is injected through the material conduit 26, it can generate a force from the front toward the back of the mold cavity 14 (e.g., from right to left in FIG. 1). The rear insert positioning mechanism 18 can be configured to withstand this force without allowing the rear insert 16 to move rearward (e.g., to the left in FIG. 1), which would undesirably change the size of the mold cavity 14. The one or more front insert positioning mechanisms 24 can also be configured to withstand the force exerted by the molten material being injected into the mold cavity 14 through the material conduit 26, e.g. to prevent the one or more front inserts 22 from moving.

The rear insert positioning mechanism 18 can also be configured to exert sufficient force to provide for compression on the molten material in the mold cavity 14 after the molten material has been injected. In an example, the rear insert positioning mechanism 18 can be configured to provide for injection compression molding of the molten material in the mold cavity 14. The term “injection compression molding,” as used herein, can refer to a process wherein the molten material is compressed within the mold cavity while it solidifies after a predetermined amount of the molten material is fed into the mold cavity. Injection compression molding can involve controlled variation of the mold cavity volume during injection or the holding pressure phases of the molding cycle, or both. The holding pressure can be applied across an entire surface of the molding so that pressure within the mold cavity can be constant or substantially constant and consistent. Injection compression molding can provide for one or more of better dimensional stability, reduced material shearing, reduction in the necessary injection pressure, and reduction in cycle time. Injection compression molding can also provide for improved holding pressure effect, which can minimize sink marks and warping of the plastic material. The rear insert positioning mechanism 18 can be configured to provide sufficient compression force necessary to achieve injection compression molding of the molten material.

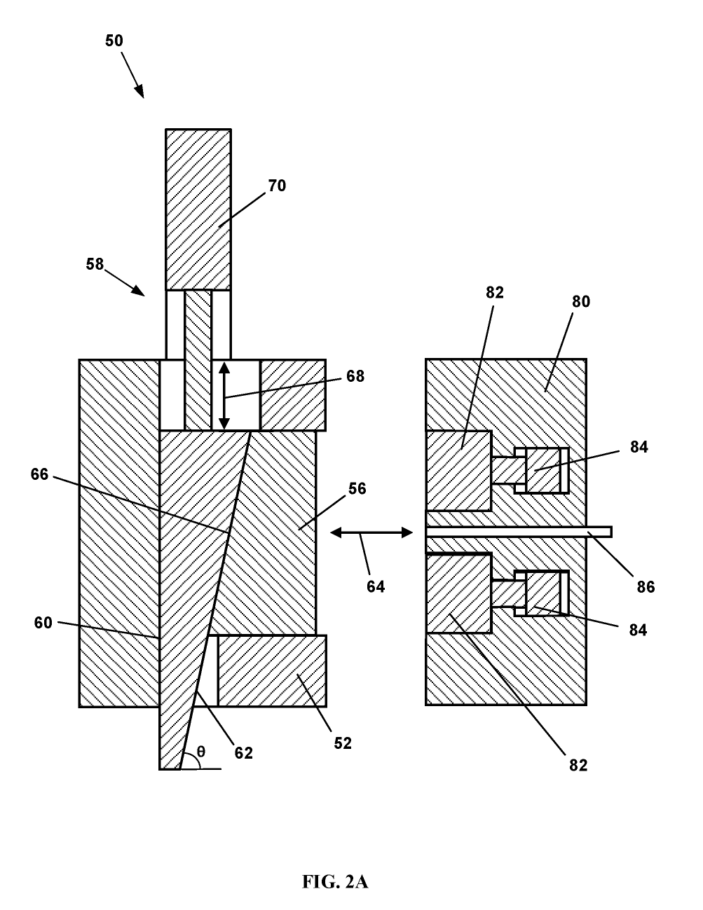

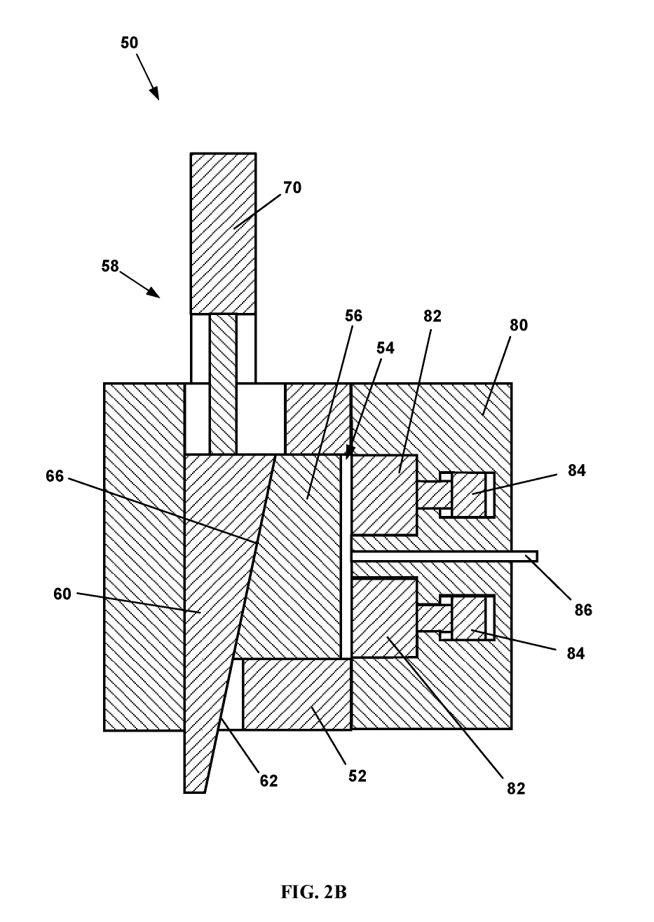

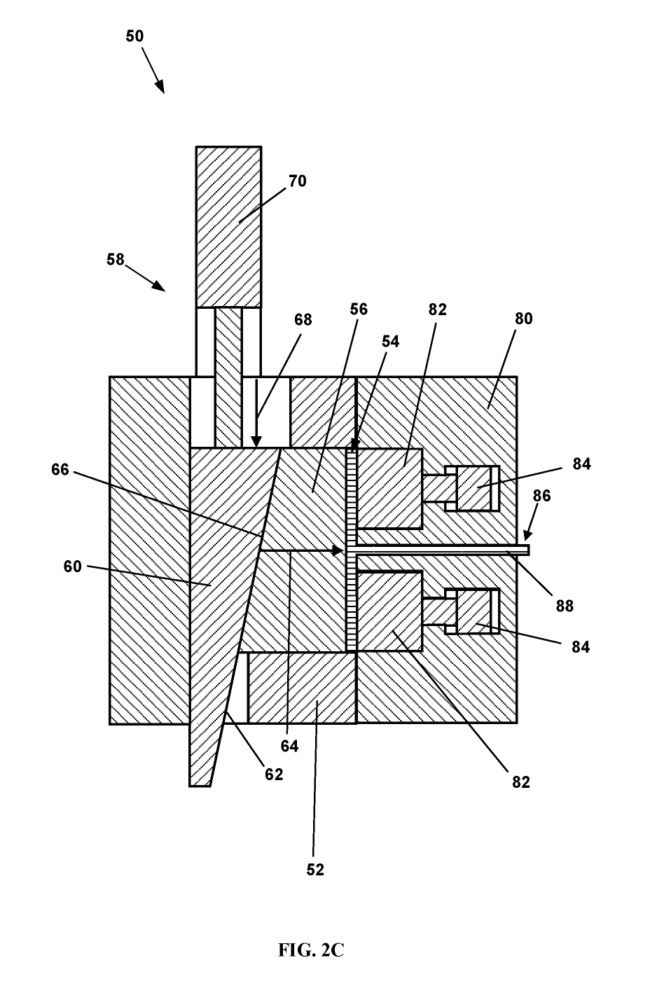

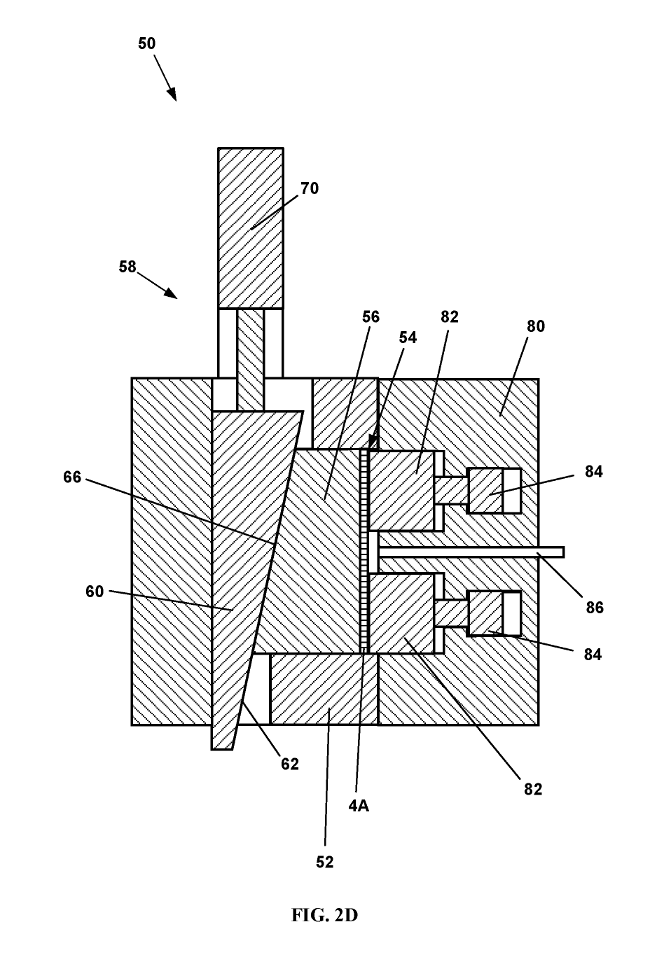

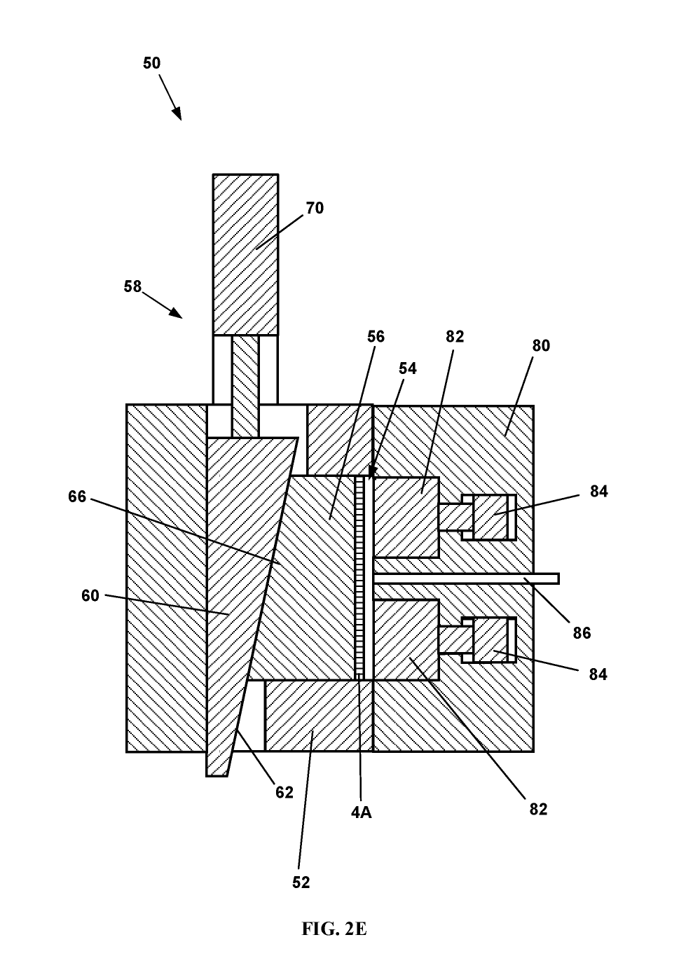

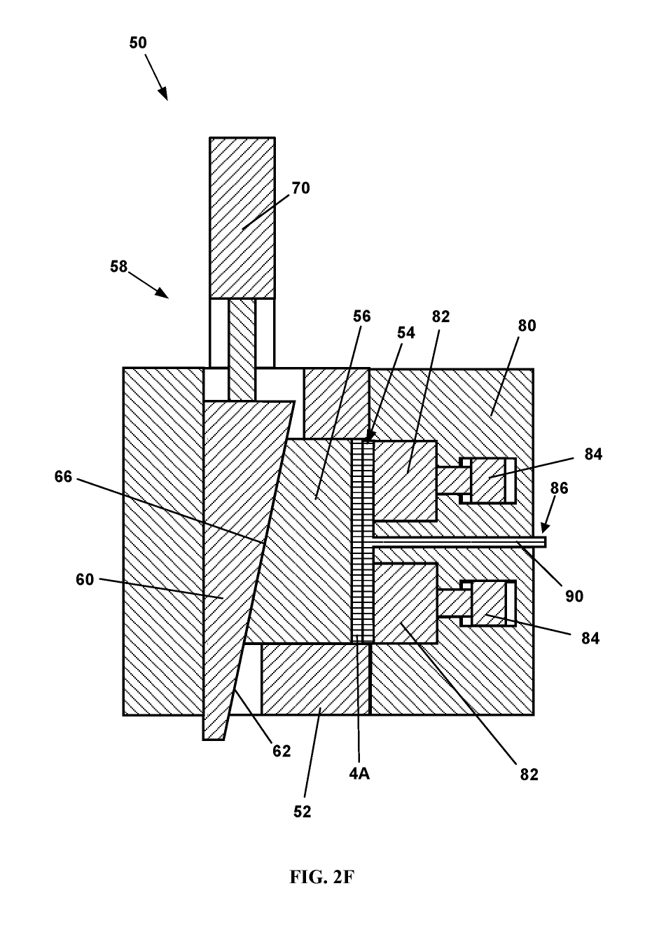

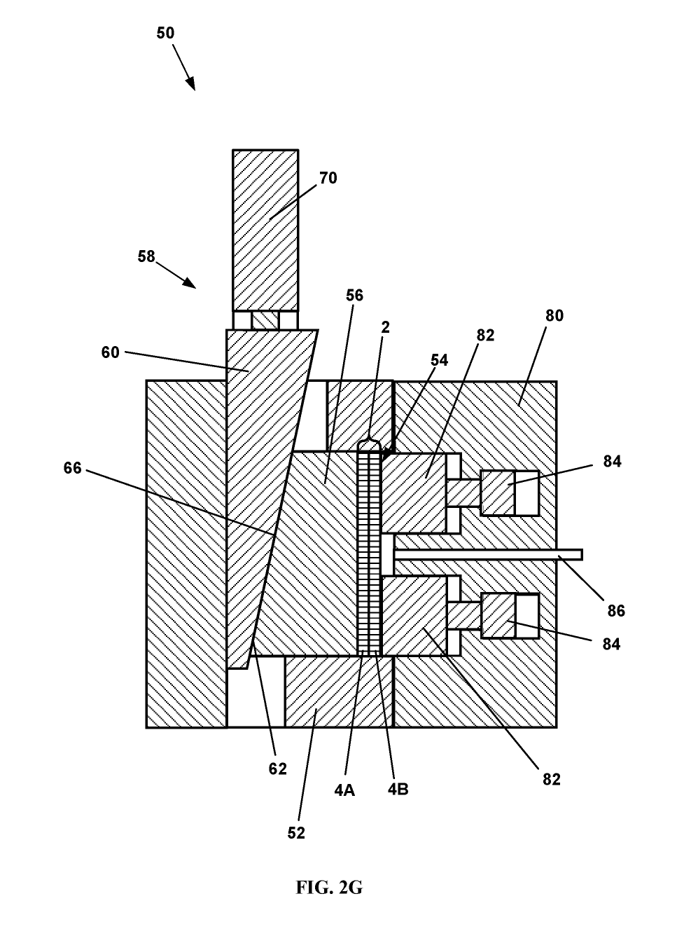

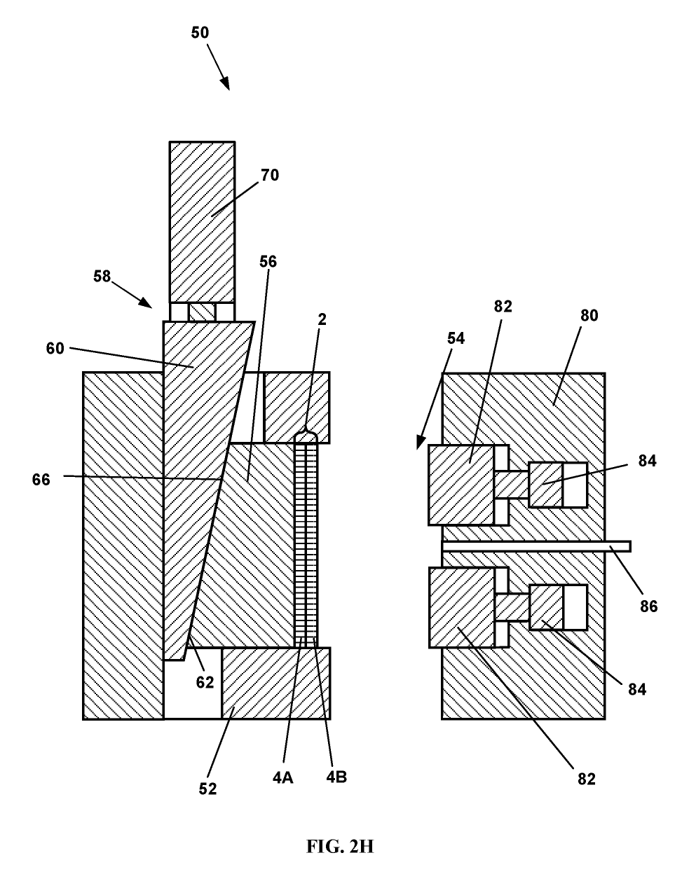

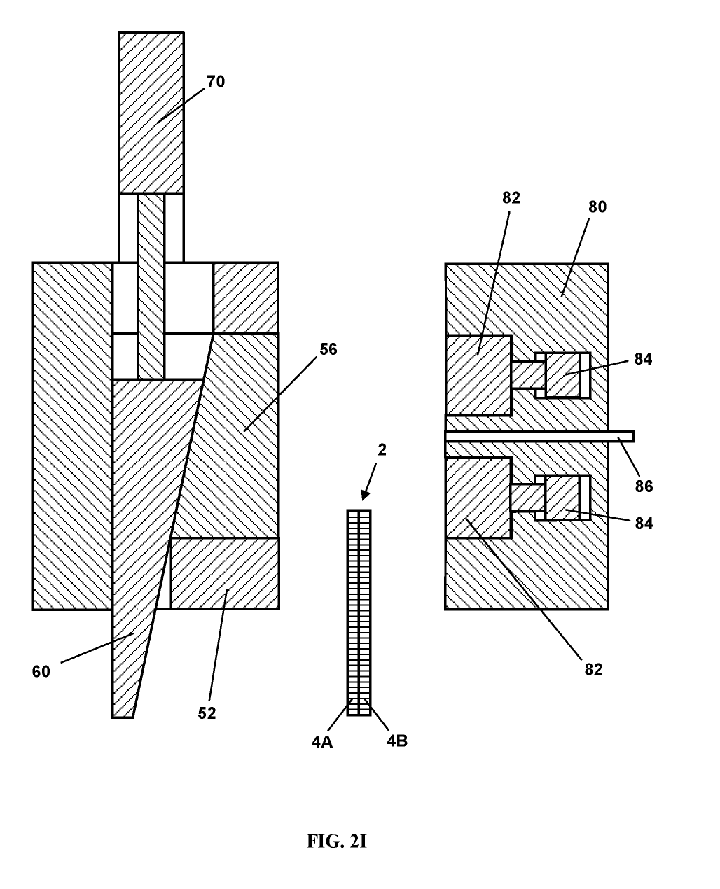

FIGS. 2A-2I show cross-sectional side views of another example molding system 50 for fabricating a block 2 as a plurality of layers 4. The molding system 50 is similar to the generic molding system 10 described above with respect to FIG. 1, but is shown with a specific example of the rear insert positioning mechanism, described in more detail below. Like the molding system 10, the molding system 50 can include a first mold section 52, also referred to herein as a rear mold section 52, that defines a first mold cavity 54 (FIG. 2B). A first insert 56, also referred to herein as a rear insert 56, can be positioned inside the mold cavity 54 and can be slidable inside the mold cavity 54 relative to the rear mold section 52 along a plurality of positions in order to adjust a dimension of the mold cavity 54. A first positioning mechanism 58, also referred to herein as a rear insert positioning mechanism 58, can be configured to move the rear insert 56 to a plurality of positions within the mold cavity 54.

As shown, for example in FIG. 2A, rather than being depicted as a generic block, the rear insert positioning mechanism 58 is shown as including a wedge 60 comprising an angled surface 62 that is angled relative to a direction of motion of the rear insert 56 (depicted as arrows 64 in FIG. 2A) at an angle θ. The rear insert 56 can also include a corresponding angled surface 66 that is also angled relative to the direction of motion 64. Preferably, the angle of the angled surface 66 of the rear insert 56 is equal or substantially equal to the angle θ as the wedge angled surface 62. The angled surface 66 of the rear insert 56 can be abutted against the wedge angled surface 62 such that the angled surface 66 mates with the wedge angled surface 62 so that when the wedge 60 is moved in the wedge direction of motion (depicted as arrows 68 in FIG. 2A), the wedge angled surface 62 will engage the insert angled surface 66 to move the rear insert 56 in the direction of motion 64.

In an example, the rear insert 56 and the wedge 60 can include a sliding locking mechanism (not shown) that keeps the wedge angled surface 62 engaged with the insert angled surface 66, e.g., by preventing the wedge angled surface 62 from being pulled away from the insert angled surface 66. In a example, the sliding locking mechanism can include one or more tongues on the wedge 60 that can be inserted into and can slide along one or more corresponding grooves in the rear insert 56, or vice versa with one or more tongues on the rear insert 56 that can be inserted into and can slide along one or more corresponding groove in the wedge 60. In an example, the sliding locking mechanism can comprise a dove tail sliding mechanism.

A sliding locking mechanism can ensure that when the wedge 60 is moved in a first direction (e.g., down in FIG. 2A) then the rear insert 56 will be driven in a corresponding first direction (e.g., to the right in FIG. 2A), and when the wedge 60 is moved in a second direction that is generally opposite of the first direction (e.g., up in FIG. 2A), then the rear insert 56 will be driven in a corresponding second direction opposite of the corresponding first direction (e.g., to the left in FIG. 2A). In the example shown in FIG. 2A, the direction of motion 68 of the wedge 60 is perpendicular or substantially perpendicular to the direction of motion 64 of the rear insert 56 as it is being driven by the wedge 60. In an example, the direction of motion 64 of the rear insert 56 is horizontal or substantially horizontal within the mold cavity 54 while the direction of motion 68 of the wedge 60 is vertical or substantially vertical, as depicted in FIG. 2A.

The rear insert positioning mechanism 58 can also include a driving piston 70 that can be configured to move the wedge 60. The driving piston 70 can supply sufficient force to drive the wedge 60 in the wedge direction of motion 68, which can, in turn, drive the rear insert 56 in the insert direction of motion 64.

In an example, the angle θ of the wedge angled surface 62 can be less than 90°. The specific value of the angle θ can be selected depending on a desired force to be exerted by the driving piston 70, e.g., to withstand the injection force produced by the molten material when it is injected into the mold cavity 54 or the force necessary to provide for injection compression molding of the molten material in the mold cavity 54. The force needed to be applied by the driving piston 70 can be directly related to the value of the angle θ. The angle θ can also be selected to control the motion of the rear insert 56 as it is driven by the wedge 60, for example because the angle θ can determine the ratio of the distance that the wedge 60 travels in the direction of motion 68 that is translated to the rear insert 56 in the direction of motion 64. In an example, the angle θ can be from about 45° to about 90° (e.g., an angle relative to the direction of motion 68 of the wedge 60 that is from about 0° to about 45°), such as from about 60° to about 88° (e.g., an angle relative to the direction of motion 68 that is from about 2° to about 30°), for example from about 65° to about 85° (e.g., an angle relative to the direction of motion 68 that is from about 5° to about 25°). In certain examples, the angle θ can be about 85° (e.g., an angle relative to the direction of motion 68 of the wedge 60 that is about) 5°, about 80° (e.g., an angle relative to the direction of motion 68 that is about 10°), about 75° (e.g., an angle relative to the direction of motion 68 that is about 15°), about 70° (e.g., an angle relative to the direction of motion 68 that is about 20°), or about 65° (e.g., an angle relative to the direction of motion 68 that is about 25°).

A mechanism that can provide for continuous or substantially continuous positioning of the rear insert 56, such as the rear insert positioning mechanism 58, can provide for essentially infinitely adjustable control over the positioning and movement of the rear insert 56, which in turn can provide for essentially infinite adjustability of the thickness of the layers 4 in order to optimize fabrication of the block 2. For example, the amount of time it takes each layer 4 of the block 2 to set can depend on the specific material being molded as well as the thickness of each layer 4, as described above with respect to Equation [1]. Thus, an optimal thickness of the layers 4 for a desired thickness of the block 2 can vary greatly depending on the material being molded. For example, the wedge 60 comprising the angled surface 62 that can bear on the corresponding angled surface 66 of the rear insert can allow the rear insert 56 to be positioned at essentially any position along the continuum from a front end of the mold cavity 54 to a practical rear boundary, e.g., a rear-most position that the rear insert 56 can be positioned while still being securely held within the rear mold section 52. Therefore, the same system 50 can be used to produce a first block 2 made from a first material where an optimal thickness of the layers 4 is about 0.1 mm and to produce a second block 2 made from a second material where the optimal thickness of the layers 4 is 10 mm, or can be used to make blocks from layers having thicknesses anywhere in between. The wedge 60 can also provide more control over the force exerted onto the rear insert 56, which in turn can provide more control over the force exerted on the molding material within the mold cavity 54. In addition, the wedge 60 can improve, and even optimize, the transmission of load by amplification of the nominal force applied by the driving piston 70. The angle between the wedge 60 and the rear insert 56 can result in the ratio of the force exerted of force applied by the driving piston 70 to the holding force that the rear insert 56 can apply on the injected polymer in the mold cavity 54 resulting in a small force produced by the driving piston 70 being able to hold high forces generated by the pressure of the injected polymer. In some examples, depending on the angle and this force ratio, the system can be self-breaking.

The molding system 50 can also include a second mold section 80, also referred to herein as a front mold section 80. The front mold section 80 can define a second mold cavity (not shown) that can be disposed adjacent to the first mold cavity 54 to form an overall mold cavity. The front mold section 80 can be disposed adjacent to the rear mold section 52 in order to enclose the mold cavity 54. The molding system 50 can include one or more mechanisms (not shown) to compress the front mold section 80 against the rear mold section 52, or vice versa. One or more second inserts 82, also referred to as one or more front inserts 82, can be included within the front mold section 80. The front inserts 82 can be configured to position the block 2 within the mold cavity 54. One or more second positioning mechanisms 84, also referred to herein as front insert positioning mechanisms 84, can be included and configured to move the front inserts 82 back and forth relative to the front mold section 80.

A material conduit 86 can pass through one or more of the rear mold section 52, the rear insert 56, the rear insert positioning mechanism 58, the front mold section 80, one or more of the front inserts 82, or one or more of the front insert positioning mechanisms 84. As shown in the example of FIG. 2A, the material conduit 86 can pass through the front mold section 80.

FIGS. 2A-2I show a schematic representation of an example method for fabricating a block 2 comprising a plurality of layers 4 using the system 50. First, the molding system 50 is provided or received. The rear mold section 52 and the front mold section 80 can be open and separated, as shown in FIG. 2A. Next, the molding system 50 can be closed by positioning the rear mold section 52 adjacent to the front mold section 80 so that the mold cavity 54 is formed and surrounded by the mold sections 52, 80, as shown in FIG. 2B. The rear mold section 52 can be clamped or otherwise secured to the front mold section 80. The rear insert 56 can be positioned by the rear insert positioning mechanism 58 at a first position corresponding to a first layer 4 of the block 2 so that the mold cavity 54 has a thickness that is relatively small (e.g., in the left-to-right direction in FIG. 2B). The initial thickness of the mold cavity 54 (which corresponds to the thickness of a first layer 4 formed in the mold cavity 54) can vary depending on the polymer or other material being used to form the block 2, for example based on solidifying properties including setting time, shrinkage, etc. In an example, the initial thickness of the mold cavity 54 can be from about 0.5 mm to about 5 mm, such as about 1 mm to about 3 mm, for example about 2 mm.

Next, a molten material 88 (e.g., a molten polymer) can be injected into the mold cavity 54 through the material conduit 86, as shown in FIG. 2C. The rear insert positioning mechanism 58 (e.g., the wedge 60 and the driving piston 70) can be configured to provide a compression force during injection of the molten material 88 or soon thereafter in order to provide for injection compression molding of the molten material 88 within the mold cavity 54, as described above. In an example, the wedge 60 can be driven downward in the direction of motion 68, which in turn can drive the rear insert 56 forward (e.g., to the right in FIG. 2C) in the direction of motion 64 to provide the compression necessary for injection compression molding.

After the molten material 88 is injected, it can be allowed to solidify to form a first molded layer 4A of the block 2 (FIG. 2D). Next, the wedge 60 can be raised by the driving piston 70. If the wedge 60 is coupled to the rear insert 56 by a sliding locking mechanism, described above, then the upward movement of the wedge 60 can cause the rear insert 56 to move rearward (e.g., to the left in FIG. 2C) so that the rear insert 56 is positioned in a second position corresponding to a second layer 4 of the block 2. The one or more front inserts 82 can push the first molded layer 4A rearward so that the first molded layers 4A remains in contact with the rear insert 56, as shown in FIG. 2D. The one or more front insert positioning mechanisms 84 can also be configured to push the rear insert 56 rearward to be in contact with the wedge 60 if a sliding locking mechanism between the wedge 60 and the rear insert 56 is not present. The one or more front inserts 82 can be withdrawn back into the front mold section 80, leaving a space within the mold cavity 54, as shown in FIG. 2E.

Additional molten material 90 can be injected into the space within the mold cavity 54 through the material conduit 86, as shown in FIG. 2F, similar to the step of the method described above with respect to FIG. 2C. The additional molten material 90 can be the same material as the molten material 88 injected in the step of FIG. 2C, or the additional molten material 90 can be a different material, depending on the desired properties of the block 2. As with the step depicted in FIG. 2C, the rear insert positioning mechanism 58 can be configured to provide a compression force on the additional molten material 90 within the mold cavity 54 to provide for injection compression molding.

The additional molten material 90 can be allowed to set within the mold cavity 54 to form a second molded layer 4B (FIG. 2G). The second molded layer 4B will be mechanically bonded to the first molded layer 4A, e.g., because the layers 4A, 4B were molded together within the same mold cavity 54 with the molten material 90 being allowed to set while it is in contact with the first layer 4A. The coupled layers 4A, 4B can form a block 2 (FIG. 2G) of the molded materials. Next, the wedge 60 can be raised by the driving piston 70, and, if the wedge 60 is coupled to the rear insert 56 by a sliding locking mechanism then the upward movement of the wedge 60 can cause the rear insert 56 to move rearward (e.g., to the left in FIG. 2F), e.g., to a third position that can correspond to a third layer 4 of the block 2. The one or more front inserts 82 can push the block 2 comprising the first molded layer 4A and the second molded layer 4B rearward so that the block 2 remains in contact with the rear insert 56, as shown in FIG. 2G.

In the example method depicted in FIGS. 2A-2G, the block 2 has reached its desired thickness with only two layers 4A, 4B, as shown in FIG. 2G. If additional molded layers 4 are needed in order to achieve a desired thickness of the block 2 (for example the four layers 4 depicted in FIG. 1), however, then the steps depicted in FIGS. 2E, 2F, and 2G can be repeated to form additional layers 4 (e.g., a third layer, a fourth layer, a fifth layer, and so on). These steps can be repeated as many times as needed to achieve the desired thickness for the block 2.

After reaching a desired thickness of the block 2, e.g., by molding the necessary number of layers 4 through the steps depicted in FIGS. 2A-2G, the molding system 50 can be opened by separating the rear mold section 52 from the front mold section 80, as shown in FIG. 2H. The block 2 can be expulsed from the space of the mold cavity 54, for example by driving the wedge 60 with the driving piston 70 in order to push the rear insert 56 forward (e.g., to the right), as shown in FIG. 2I.

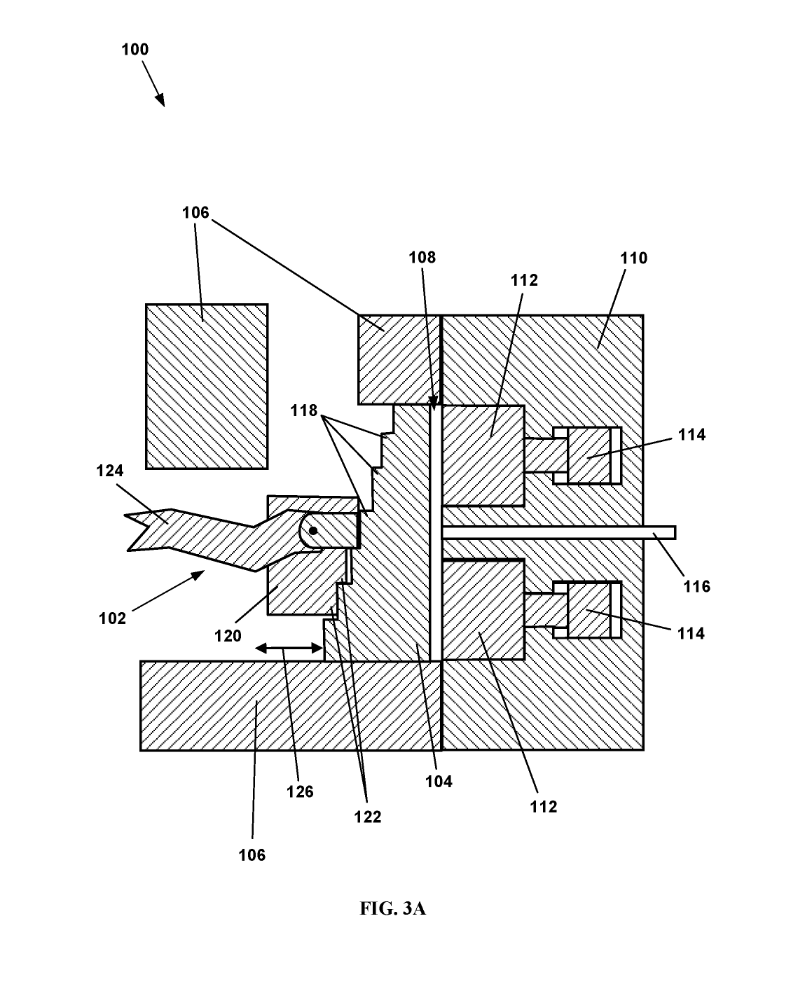

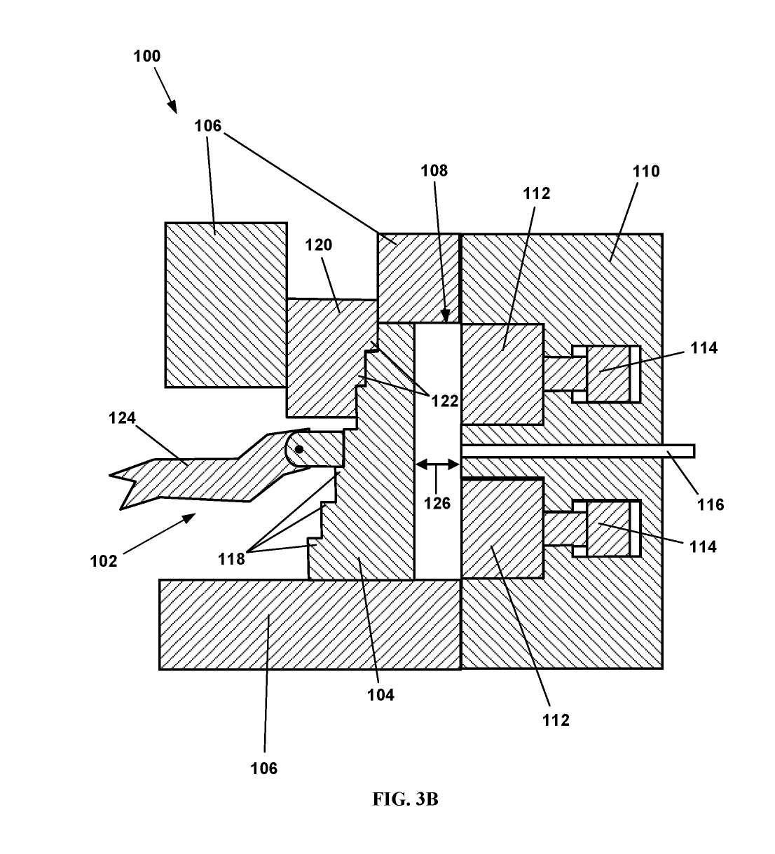

The molding system 50 shown in FIGS. 2A-2I includes the rear insert positioning mechanism 58 comprising the wedge 60 with the angled surface 62 that can bear on the corresponding angled surface 66 of the rear insert 56. As noted above, this design can provide for greater control over the thickness of the layers 4 that form the block 2 and over the force exerted on the molding material by the rear insert 56. However, continuous and infinite control over the positioning of the rear insert 56 may not be necessary. FIGS. 3A and 3B show an example molding system 100 with an alternative first insert positioning mechanism 102, also referred to as a rear insert positioning mechanism 102, that can provide for positioning of a first insert 104, also referred to as a rear insert 104, relative to a first mold section 106, also referred to as a rear mold section 106. The rear mold section 106 can partially enclose a mold cavity 108. The rear insert 104 can be positioned in and slidable along the mold cavity 108 relative to the rear mold section 106 in order to change a size of the mold cavity 108.

The molding system 100 can also include a second mold section 110, also referred to herein as a front mold section 110. The front mold section 110 can be posited adjacent to the rear mold section 106 in order to enclose the mold cavity 108. One or more second inserts 112, also referred to as one or more front inserts 112, can be included within the front mold section 110, which can be moved back and forth relative to the front mold section 110 by one or more second positioning mechanisms 114, also referred to herein as front insert positioning mechanisms 114. A material conduit 116 can provide a pathway for molten material to be injected into the mold cavity 108.

The rear insert positioning mechanism 102 can be configured to move the rear insert 104 back and forth to a plurality of discrete positions relative to the rear mold section 106. In the example shown in FIGS. 3A and 3B, the rear insert positioning mechanism 102 can include a ratcheting-type mechanism for positioning the rear insert 104 at a plurality of discrete positions relative to the rear mold section 106. The rear insert 104 can include a plurality of ratchet stairs 118 and the rear insert positioning mechanism 102 can include a pawl 120 with corresponding stair-like teeth 122 that can engage the ratchet stairs 118 of the rear insert 104. The rear insert positioning mechanism 102 can also include an expulsion rod 124 coupled to the rear insert 104. The pawl 120 can begin in a first position, e.g., a bottom position, as shown in FIG. 3A. The expulsion rod 124 can be biased to pull the rear insert 104 in a rearward direction, e.g., to the left in FIG. 3A, against the pawl 120. The pawl 120 can be biased in a downward direction. The teeth 122 of the pawl 120 can engage the ratchet stairs 118, which can, in addition to the pulling of the expulsion rod 124, prevent the rear insert 104 from sliding in the direction of motion 126 of the rear insert 104 (e.g., left to right in FIG. 3A). The engagement between the teeth 122 of the pawl 120 and the ratchet stairs 118 of the rear insert 104, along with the biasing force against the pawl 120, can prevent the pawl 20 from sliding vertically.

After molten material is injected into the mold cavity 108 and allowed to set, the biasing force against the pawl 120, e.g., keeping the pawl 120 biased downward, can be overcome and the pawl 120 can be moved upward by at least one position relative to the rear insert 104. Each of the teeth 122 of the pawl 120 can move up one position and engage a new one of the ratchet stairs 118 of the rear insert 104. The biasing force pulling on the expulsion rod 124 can move the rear insert 104 rearward by one position relative to the rear mold section 106, as shown in FIG. 3B, so that the rear insert 104 and the block within the mold cavity 108 (not shown in FIGS. 3A and 3B) provide additional space for an additional layer of material to be added to the block.

The ratcheting processing can be repeated until a desired number of layers have been molded and the block is complete, at which point the molding system 100 can be opened by separating the rear mold section 106 from the front mold section 110. The biasing force on the expulsion rod 124 can be overcome and the expulsion rod 124 can be driven forward to expulse the block from the mold cavity 108 and to reposition the rear insert 104 in the forward-most starting position. As the rear insert 104 moves forward, the ratchet stairs 118 of the rear insert 104 move out of the way of the teeth 122 of the pawl 120 so that the biasing force acting on the pawl 120 can drive the pawl 120 back downward to its starting position where the process can be started over again.

A mechanism that can provide for positioning of the rear insert 104 to a plurality of discrete positions, such as the rear insert positioning mechanism 102, can be used when the properties and setting behavior of the molding material is well known and the molding system 100 is to be used only for that well-known molding material. In such a scenario, it can be more efficient, economical, and reliable to use a system with discrete positioning of the rear insert 104 rather than the infinitely adjustable system 50 depicted in FIGS. 2A-2I, which provides more flexibility, but can also be more complicated and can have more potential for malfunction. The molding system 100 can be particularly useful for an overall manufacturing operation where the operation of the molding system 100 will not change, e.g., in a large-scale manufacturing process where the molding system 100 is just one piece of equipment in the process.

For some molding materials, the method of preparing a block, such as the method shown in FIGS. 2A-2I to form the block 2, may need to be modified to accommodate mechanical properties of the molding material. In an example, the molding material used to form the block 2 can shrink relatively rapidly due to cooling after the block 2 is removed from the mold cavity 54, e.g., if the molding material has one or more of a relatively high coefficient of thermal expansion (CTE), a relatively high specific heat (e.g., the temperature change of a set mass of the material per unit of heat energy added or remove), and a relatively high heat conductivity (e.g., the rate at which heat transfers from the interior of the block 2 toward the exterior of the block). Some molding materials that cool relatively quickly and shrink relatively rapidly when cooled can also have a relatively low ductility such that, as the molding material shrinks relatively rapidly, the material cannot resist the internal tension being created by the shrinking, which can lead to cracking and failure of the bock 2.

In addition, for molding materials that are processed at relatively high temperature, e.g., due to a high melting temperature needed to make the material workable for a molding process, cracking or failure of the molding material can occur even if the material has a CTE, specific heat, and ductility that could be expected to accommodate shrinking of the material because: (a) there is a large thermal driving force due to the large difference in temperature between the block 2 and the surrounding air; and (b) the material must accommodate such a large change in temperature to get the block 2 down to a usable temperature, e.g., room temperature.

An example of a material that exhibits this kind of cracking and failure when forming a block 2 by the methods described herein is polyether ether ketone (PEEK). PEEK has a relatively high melting temperature, about 343° C., so that when a PEEK block 2 can be at a very high temperature when it is ejected from the molding system 50. PEEK also has a relatively high CTE, which can be as high as about 140 parts per million by weight per degree Kelvin (ppm/° K) when PEEK is above its glass transition temperature (about 143° C.), and about 445 ppm/° K. PEEK also has a relatively high heat conductivity and specific heat, e.g., it will cool quickly, and it has a relatively low ductility. In short, a block 2 made of PEEK will come out of the mold at a high temperature, e.g., as high as 300° C., and will thus be driven to cool rapidly due to its high heat conductivity, specific heat, and the heat transfer to the air around the block 2. This will lead to a high shrink rate of the PEEK block 2 due to PEEK's high CTE, which can lead to the PEEK block 2 cracking because its ductility cannot accommodate the high shrink rate.

In some examples, and in particular with blocks 2 of larger sizes (e.g., larger cross-sectional areas or larger thicknesses, or both), the block 2 can experience temperature gradients between interior regions of the block 2 compared to regions near the block surface. For example, for a large block 2 having a cross-sectional area of at least 2000 cm² (e.g., a 50 cm by 50 cm block (cross-sectional area 2500 cm²), and/or having a thickness of at least 5 cm (e.g., an 8 cm thick block), or even less for molding materials having the unfavorable thermal properties described above, a core of the block 2 can remain relatively higher than regions near the block surfaces because it can take awhile for the thermal energy to transfer from the core to the outer block surfaces where it can be expelled. The temperature gradient can lead to different regions of the block 2 shrinking by different amounts and at different rates. When the temperature gradient becomes large enough, the block 2 can crack or otherwise fail even if the molding material of the block does not have the unfavorable thermal properties described above.

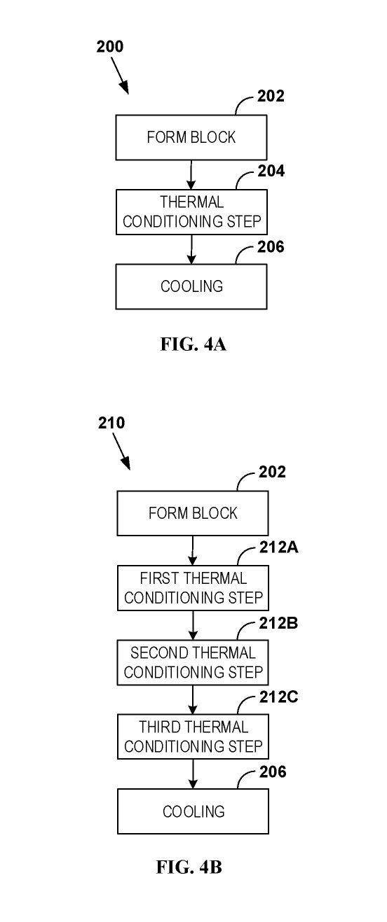

FIGS. 4A and 4B show examples of methods 200, 210 of thermally treating a block after it has been molded with the molding systems and molding methods described herein, e.g., a block 2 molded by the molding systems 50 in FIG. 1 or 100 in FIGS. 3A and 3B and by the method of FIGS. 2A-2I. One or both of the methods 200, 210 can be particularly useful for molding materials having one or more of: a relatively high melting temperature, e.g., greater than about 300° C., or processing temperature, e.g., greater than about 350° C., such as at least 400° C.; a relatively high CTE, e.g., greater than about 30 ppm/° K, such as greater than about 40 ppm/° K, for example 45 ppm/° K (as with PEEK) or greater; a relatively high specific heat, e.g., greater than about 0.2 kilojouls per kilogram degree Kelvin (kJ/kg·° K), such as greater than about 0.3 kJ/kg·° K, for example 0.32 kJ/kg·° K (as with PEEK) or greater; a relatively high thermal conductivity, e.g., at least about 0.15 watts per meter degree Kelvin (W/m ° K), such as at least about 0.2 W/m·° K, for example 0.25 W/m·° K (e.g., the thermal conductivity of PEEK) or greater; and a relatively low ductility, e.g., less than about 5%. As noted above, PEEK is an example of such a molding material. Other examples for which the example method 200 of FIG. 4 may be useful include, but are not limited to, polystyrene, poly-methyl methacrylate (PMMA), styrene acrylonitrile (SAN), all of which are not typically molded due to their low ductility. The method 200 can also be useful for larger blocks 2, even if the molding materials of the block do not have the unfavorable thermal properties described above in order to avoid or minimize the chances of cracking or block failure due to uneven temperature distribution or uneven block 2 shrinking, or both.

As shown in FIGS. 4A and 4B, the method 200 can include forming a block 202. In an example, forming the block 202 be similar or identical to the methods of molding the block 2 described above with respect to FIGS. 2A-2I. For this reason, forming the block 202 will be referred to as molding the block 202 in reference to the method 200. However, a person of skill in the art will appreciate that other methods of forming the block, including methods other than those performed by the system of FIGS. 1, 3A, and 3B, or via methods other than those described above with respect to FIGS. 2A-2I.

After the block 2 has been formed (202), the method 200 can include, at 204, thermally conditioning the block 2. As described above, various factors of the block 2 can result in cracking or failure of the block 2 due to rapid or uneven cooling, and thus rapid or uneven shrinking of the block 2 during cooling, (e.g., block size, thermal properties of the molding material used to form the block 2). The thermal conditioning of the block 2 can provide one or more intermediate cooling steps that will allow the block 2 to achieve one or more intermediate temperatures between the processing temperature at which the block 2 leaves the molding 202 and a final, cooled temperature (e.g., room temperature), while reducing or minimizing rapid shrinking or non-uniform shrinking, or both, of the block 2.

In an example, shown in FIG. 4A, a thermal conditioning method 200 can include a single thermal conditioning step 204 where the block 2 is held at a single intermediate temperature between the processing temperature associated with molding the block 202 and the final cooled temperature. In another example, shown in FIG. 4B, an example method 210 can include a plurality of thermal conditioning steps, e.g., two or more thermal conditioning steps. In the example shown in FIG. 4B, the method 210 includes three thermal conditioning steps: a first thermal conditioning step 212A, wherein the surroundings of the block 2 are held at a first intermediate temperature that is lower than the processing temperature but higher than the final cooled temperature; a second thermal conditioning step 212B performed after the first thermal conditioning step 212A, wherein the surroundings of the block 2 are held at a second intermediate temperature that is lower than the first intermediate temperature but higher than the final cooled temperature; and a third thermal conditioning step 212C performed after the second thermal conditioning step 212B, where the surroundings of the block 2 are held at a third intermediate temperature that is lower than the second intermediate temperature, but higher than the final cooled temperature.

Each thermal conditioning step 204 can also allow the block 2 to reach a uniform or substantially uniform intermediate temperature throughout the block 2, e.g., in the block core and at the block surfaces, before allowing the block 2 to be cooled in a subsequent cooling step. Uniform or substantially uniform temperature can minimize or reduce uneven or non-uniform shrinking of the block 2 during cooling, which can minimize or reduce cracking or other damage to the block 2.

In an example, the thermal conditioning step 204 can include holding the environment surrounding the block 2 at one or more intermediate temperatures between the processing temperature (e.g., molding temperature) of the material of the block 2 and a final cooled temperature to which the block 2 will be cooled, such as room temperature, e.g., around 20° C. The thermal conditioning step 204 can include holding the block 2 for a specified period time for each of the one or more intermediate temperatures.

The number of intermediate temperatures (e.g., the number of thermal conditioning steps 204, 212A, 212B, 212c), the specific temperatures for each of the one or more thermal conditioning steps 204, 212A, 212B, 212C, and the duration of each thermal conditioning step 204, 212A, 212B, 212C (e.g., the amount of time that the environmental surroundings of the block 2 are held at each of the one or more intermediate temperatures) can be selected based on several factors including, but not limited to, one or more of:
(a) the processing temperature of the molding material of the block 2, both in the absolute sense (e.g., the actual temperature of the block 2 as it exits the mold), and how much higher the processing temperature is than the temperature of the thermal conditioning step 204 in a method 200 with a single thermal conditioning step 204 or the first thermal conditioning step 212 in a multi-thermal conditioning step method 210;
(b) one or more thermal properties of the molding material that forms the block 2, such as coefficient of thermal expansion, specific heat, and thermal conductivity;
(c) one or more mechanical properties of the molding material of the block, such as ductility or modulus;
(d) the temperature to which the block 2 is to be cooled, e.g., the final cooled temperature; and
(e) the amount of time in which the block 2 has to cool in order to reach the final cooled temperature, e.g., the desired processing time.

The specific intermediate temperature for each thermal conditioning step 204, 212A, 212B, 212C can also depend on the difference in temperature between the preceding step and the desired final cooled temperature. The duration of each thermal conditioning step 204, 212A, 212B, and 212C can also depend on the difference in temperature between the intermediate temperature for that thermal conditioning step 204, 212A, 212B, 212C and the temperature of the preceding processing step. For example, when there is only one thermal conditioning step 204, as in the example method 200 of FIG. 4A, then the difference between the processing temperature for molding the block 202 and the thermal conditioning step 204 can determine the duration of the thermal conditioning step 204, e.g., with a larger difference in temperature tending to require a longer duration for the thermal conditioning step 204 so that the substantially the entirety of the block 2 can reach the intermediate holding temperature of the thermal conditioning step 204 so that the block 2 has a uniform or substantially uniform temperature throughout.

In an example, thermal conditioning (e.g., the single thermal conditioning step 204 or the plurality of thermal conditioning steps 212A, 212B, and 212C) can include placing the block 2 in an interior of a thermal conditioning oven or other heating device. The thermal conditioning oven can be configured to hold the temperature within the interior at a set temperature, e.g., the specific intermediate temperature of the thermal conditioning step 204, 212A, 212B, 212D. The thermal conditioning oven can include a temperature control system to control the temperature within the interior of the thermal conditioning oven to reach a set point. In an example, the control system can include a temperature sensor, a heating device, and a controller to control the heating output of the heating device based on a temperature measured by the temperature sensor compared to a set temperature. The control system can also including a timing device configured to maintain the temperature in the thermal conditioning oven at the set point for a specified period of time before releasing the block 2 from the thermal conditioning oven at the conclusion of the thermal conditioning step 204 (as in the method 200 of FIG. 4A) or the final thermal conditioning step 212C (as in the method 210 of FIG. 4B).

After the thermal conditioning step 204 or the final thermal conditioning step 212C, at 206, the method 200, 210 can include cooling the block 2 to a final cooled temperature. In an example, the cooling 206 can include exposing the block 2 to air in order to allow the block 2 to cool down to the temperature of the air. For this reason, the step of cooling 206 will be referred to herein as air cooling 206. Other methods of cooling the block 2 can be used, such as cooling fans, fooling liquids or other cooling fluids, chillers, and the like.

For the purpose of illustration, a method of thermal conditioning (e.g., method 200) will be described for a specific material, in this case polyether ether ketone (PEEK), which, as noted above, has thermal and mechanical properties that can result in cracking or other failure of a block 2 as it cools from the processing temperature of molding the block 202 to the specified final cooled temperature. The specific details of the exemplary method described with respect to PEEK are not intended to be limiting, but are simply meant for the purposes of illustration. Other processing parameters may be used for other materials, or even for another method using PEEK as the molding material, but where other factors (such as block size or environmental conditions) are different.

In the exemplary method, 25 centimeter (cm) long by 25 cm wide by 8 cm thick blocks of PEEK was molded, for example via the method shown in FIGS. 2A-2I. The PEEK blocks exited the molding system at a temperature of about 200° C. One PEEK block was simply taken out of the molding system and allowed to air cool. Internal stresses due to air cooling of the PEEK block resulted in cracking and total failure of the block after about 3 hours of cooling.

A second PEEK block was placed into an oven substantially immediately after molding. The oven was set at 120° C., and the PEEK block was kept in the oven for 2 hours so that the temperature of the PEEK block was substantially uniform at about 120° C. after thermal conditioning in the oven. The PEEK block at 120° C. was removed from the oven and allowed to cool for another 2 to 3 hours until the temperature of the PEEK block was substantially uniformly at about 20° C. The PEEK block that was placed in the oven at 120° C. as an intermediate thermal conditioning step did not crack or fail.

To better illustrate the molding system and method of fabricating a block of the present disclosure, a non-limiting list of Examples is provided here:

EXAMPLE 1 can include subject matter (such as an apparatus, a device, a method, or one or more means for performing acts), such as can include a molding system for fabricating a part. The subject matter can include a first mold section defining a first mold cavity, a first insert slidable to a plurality of positions relative to the first mold cavity to adjust a dimension of the mold cavity, a second mold section to be disposed adjacent to the first mold section to at least partially enclose the first mold cavity, a molding material conduit to be disposed in fluid communication with the first mold cavity, and a positioning mechanism configured to move the first insert to the plurality of positions relative the first mold cavity.

EXAMPLE 2 can include, or can optionally be combined with the subject matter of EXAMPLE 1, to optionally include the positioning mechanism comprising a wedge having an angled surface.

EXAMPLE 3 can include, or can optionally be combined with the subject matter of EXAMPLE 2, to optionally include the angled surface of the wedge bearing on a corresponding angled surface of the first insert.

EXAMPLE 4 can include, or can optionally be combined with the subject matter of either one of EXAMPLES 2 or 3, to optionally include the angled surface of the wedge forming an angle with a direction of movement of the first insert from about 45° to about 90°.

EXAMPLE 5 can include, or can optionally be combined with the subject matter of any one of EXAMPLES 2-4, to optionally include the angled surface of the wedge forming an angle with the direction of movement of the first insert from about 60° to about 88°.

EXAMPLE 6 can include, or can optionally be combined with the subject matter of any one of EXAMPLES 2-5, to optionally include the angled surface of the wedge forming an angle with the direction of movement of the first insert being about 65° to about 85°.

EXAMPLE 7 can include, or can optionally be combined with the subject matter of any one of EXAMPLES 2-6, to optionally include the angled surface of the wedge forming an angle with the direction of movement of the first insert of about 80°.

EXAMPLE 8 can include, or can optionally be combined with the subject matter of any one of EXAMPLES 3-7, to optionally include the corresponding angled surface of the first insert forming an angle with the direction of movement of the first insert that is substantially equal to the angle formed by the angled surface of the wedge.

EXAMPLE 9 can include, or can optionally be combined with the subject matter of any one of EXAMPLES 3-8, to optionally include the corresponding angled surface of the first insert forming an angle with a direction of movement of the first insert from about 45° to about 90°.

EXAMPLE 10 can include, or can optionally be combined with the subject matter of any one of EXAMPLES 3-9, to optionally include the corresponding angled surface of the first insert forming an angle with a direction of movement of the first insert from about 60° to about 88°.

EXAMPLE 11 can include, or can optionally be combined with the subject matter of any one of EXAMPLES 3-10, to optionally include the corresponding angled surface of the first insert forming an angle with a direction of movement of the first insert from about 65° to about 85°.

EXAMPLE 12 can include, or can optionally be combined with the subject matter of any one of EXAMPLES 3-11, to optionally include the corresponding angled surface of the first insert forming an angle with a direction of movement of the first insert of about 80°.

EXAMPLE 13 can include, or can optionally be combined with the subject matter of any one of EXAMPLES 2-12, to optionally include a sliding locking mechanism coupling the wedge to the first insert.

EXAMPLE 14 can include, or can optionally be combined with the subject matter of EXAMPLE 13, to optionally include the sliding locking mechanism comprising a tongue on the wedge inserted into and slidable along a corresponding groove in the first insert.

EXAMPLE 15 can include, or can optionally be combined with the subject matter of EXAMPLE 13, to optionally include the sliding locking mechanism comprising a tongue on the first insert inserted into and slidable along a corresponding groove in the wedge.

EXAMPLE 16 can include, or can optionally be combined with the subject matter of any one of EXAMPLES 1-15, to optionally include a second mechanism configured to position the solidified molding material in the mold cavity.

EXAMPLE 17 can include, or can optionally be combined with the subject matter of EXAMPLE 16, to optionally include the second mechanism comprising one or more second inserts slidable within the second mold section.

EXAMPLE 18 can include, or can optionally be combined with the subject matter of one or any combination of EXAMPLES 1-17, to optionally include the second layer being mechanically coupled and chemically coupled to the first layer to form the part after the second molten molding material sets.

EXAMPLE 19 can include, or can optionally be combined with the subject matter of one or any combination of EXAMPLES 1-18, to optionally include the predetermined second thickness being the same as the predetermined first thickness.

EXAMPLE 20 can include, or can optionally be combined with the subject matter of one or any combination of EXAMPLES 1-19, to include subject matter (such as an apparatus, a device, a method, or one or more means for performing acts), such as can include a method of fabricating a part. The subject matter can include disposing a first mold section adjacent to a second mold section to at least partially enclose a first mold cavity therebetween, positioning a slidable insert at a first position within the first mold cavity to provide a first space having a predetermined first thickness at a front end of the mold cavity, injecting a first molten molding material into the first space of the mold cavity, allowing the first molten molding material to set to form a first layer, moving the slidable insert to a second position within the mold cavity to provide a second space having a predetermined second thickness between the first layer and the front end of the mold cavity, injecting a second molten molding material into the second space of the mold cavity, and allowing the second molten molding material to set to form a second layer, the second layer being mechanically coupled to the first layer to form a part after the second molten molding material sets.

EXAMPLE 21 can include, or can optionally be combined with the subject matter of EXAMPLE 20, to optionally include the second molten molding material being the same material as the first molten molding material.

EXAMPLE 22 can include, or can optionally be combined with the subject matter of either of EXAMPLE 20 or EXAMPLE 21, to optionally include moving the slidable insert to a third position within the mold cavity to provide a third space having a predetermined third thickness between the second layer and the front end of the mold cavity.

EXAMPLE 23 can include, or can optionally be combined with the subject matter of EXAMPLE 22, to optionally include injecting a third molten molding material into the third space of the mold cavity.

EXAMPLE 24 can include, or can optionally be combined with the subject matter of EXAMPLE 23, to optionally include allowing the third molten molding material to set to form a third layer, the third layer being mechanically coupled to the second layer after the third molten molding material sets, the first layer, second layer, and third layer forming the part.

EXAMPLE 25 can include, or can optionally be combined with the subject matter of any one of EXAMPLES 22-24, to optionally include the third molten molding material being the same material as one or both of the first molten molding material and the second molten molding material.

EXAMPLE 26 can include, or can optionally be combined with the subject matter of any one of EXAMPLES 22-25, to optionally include the predetermined third thickness being the same as one or both of the predetermined first thickness and the predetermined second thickness.

EXAMPLE 27 can include, or can optionally be combined with the subject matter of any one of EXAMPLES 22-26, to optionally include: moving the slidable insert to a fourth position within the mold cavity to provide a fourth space having a predetermined fourth thickness between the third layer and the front end of the mold cavity; injecting a fourth molten molding material into the fourth space of the mold cavity; allowing the fourth molten molding material to set to form a fourth layer that is mechanically coupled to the third layer, wherein the first layer, the second layer, the third layer, and the fourth layer form the part.

EXAMPLE 28 can include, or can optionally be combined with the subject matter of EXAMPLE 27, to optionally include the fourth molten molding material being the same material as one or more of the first molten molding material, the second molten molding material, and the third molten molding material.

EXAMPLE 29 can include, or can optionally be combined with the subject matter of either EXAMPLE 27 or EXAMPLE 28, to optionally include the predetermined fourth thickness being the same as one or more of the predetermined first thickness, the predetermined second thickness, and the predetermined third thickness.

EXAMPLE 30 can include, or can optionally be combined with the subject matter of any one of EXAMPLES 27-29, to optionally include: moving the slidable insert to a fifth position within the mold cavity to provide a fifth space having a predetermined fifth thickness between the fourth layer and the front end of the mold cavity; injecting a fifth molten molding material into the fifth space of the mold cavity; allowing the fifth molten molding material to set to form a fifth layer that is mechanically coupled to the fourth layer, wherein the first layer, the second layer, the third layer, the fourth layer, and the fifth layer form the part.

EXAMPLE 31 can include, or can optionally be combined with the subject matter of EXAMPLE 32, to optionally include the fifth molten molding material being the same material as one or more of the first molten molding material, the second molten molding material, the third molten molding material, and the fourth molten molding material.

EXAMPLE 33 can include, or can optionally be combined with the subject matter of either EXAMPLE 31 or EXAMPLE 32, to optionally include the predetermined fifth thickness being the same as one or more of the predetermined first thickness, the predetermined second thickness, the predetermined third thickness, and the predetermined fourth thickness.

EXAMPLE 34 can include, or can optionally be combined with the subject matter of any one of EXAMPLES 30-33, to optionally include:
moving the slidable insert to a sixth position within the mold cavity to provide a sixth space having a predetermined sixth thickness between the fifth layer and the front end of the mold cavity;
injecting a sixth molten molding material into the sixth space of the mold cavity;
allowing the molten molding material to set to form a sixth layer that is mechanically coupled to the fifth layer;
moving the slidable insert to a seventh position within the mold cavity to provide a seventh space having a predetermined seventh thickness between the sixth layer and the front end of the mold cavity;
injecting a seventh molten molding material into the seventh space of the mold cavity;
allowing the seventh molten material to set to form a seventh layer that is mechanically coupled to the sixth layer;
moving the slidable insert to an eighth position within the mold cavity to provide an eighth space having a predetermined eighth thickness between the seventh layer and the front end of the mold cavity;
injecting an eighth molten molding material into the eighth space of the mold cavity;
allowing the eighth molten molding material to set to form an eighth layer that is mechanically coupled to the seventh layer;
moving the slidable insert to a ninth position within the mold cavity to provide a ninth space having a predetermined ninth thickness between the eighth layer and the front end of the mold cavity;
injecting a ninth molten molding material into the ninth space of the mold cavity;
allowing the ninth molten molding material to set to form a ninth layer that is mechanically coupled to the seventh layer;
moving the slidable insert to a tenth position within the mold cavity to provide a tenth space having a predetermined tenth thickness between the ninth layer and the front end of the mold cavity;
injecting a tenth molten molding material into the tenth space of the mold cavity;
allowing the tenth molten molding material to set to form a tenth layer that is mechanically coupled to the ninth layer, wherein the first layer, the second layer, the third layer, the fourth layer, the fifth layer, the sixth layer, the seventh layer, the eighth layer, the ninth layer, and the tenth layer form the part.

EXAMPLE 35 can include, or can optionally be combined with the subject matter of EXAMPLE 34, to optionally include each of the sixth molten molding material, the seventh molten molding material, the eighth molten molding material, the ninth molten molding material, and the tenth molten molding material being the same material as another one or more of the first molten molding material, the second molten molding material, the third molten molding material, the fourth molten molding material, the fifth molten molding material, the sixth molten molding material, the seventh molten molding material, the eighth molten molding material, the ninth molten molding material, and the tenth molten molding material.

EXAMPLE 36 can include, or can optionally be combined with the subject matter of either EXAMPLE 34 or EXAMPLE 35, to optionally include each of the predetermined sixth thickness, the predetermined seventh thickness, the predetermined eighth thickness, the predetermined ninth thickness, and the predetermined tenth thickness being the same as another one or more of the predetermined first thickness, the predetermined second thickness, the predetermined third thickness, the predetermined fourth thickness, the predetermined fifth thickness, the predetermined sixth thickness, the predetermined seventh thickness, the predetermined eighth thickness, the predetermined ninth thickness, and the predetermined tenth thickness.

EXAMPLE 37 can include, or can optionally be combined with the subject matter of any one of EXAMPLES 20-36, to optionally include expulsing the block from the mold cavity.

EXAMPLE 38 can include, or can optionally be combined with the subject matter of any one of EXAMPLES 20-37, to optionally include the positioning and moving of the slidable insert being performed by an insert positioning mechanism.

EXAMPLE 39 can include, or can optionally be combined with the subject matter of EXAMPLE 38, to optionally include the insert positioning mechanism comprising a wedge having an angled surface.

EXAMPLE 40 can include, or can optionally be combined with the subject matter of EXAMPLE 39, to optionally include the angled surface of the wedge bearing on a corresponding angled surface of the first insert.

EXAMPLE 41 can include, or can optionally be combined with the subject matter of either one of EXAMPLE 39 or EXAMPLE 40, to optionally include the angled surface of the wedge forming an angle with a direction of movement of the first insert from about 45° to about 90°.

EXAMPLE 42 can include, or can optionally be combined with the subject matter of any one of EXAMPLES 39-41, to optionally include the angled surface of the wedge forming an angle with the direction of movement of the first insert from about 60° to about 88°.

EXAMPLE 43 can include, or can optionally be combined with the subject matter of any one of EXAMPLES 39-42, to optionally include the angled surface of the wedge forming an angle with the direction of movement of the first insert being about 65° to about 85°.

EXAMPLE 44 can include, or can optionally be combined with the subject matter of any one of EXAMPLES 39-43, to optionally include the angled surface of the wedge forming an angle with the direction of movement of the first insert of about 80°.

EXAMPLE 45 can include, or can optionally be combined with the subject matter of any one of EXAMPLES 40-44, to optionally include the corresponding angled surface of the first insert forming an angle with the direction of movement of the first insert that is substantially equal to the angle formed by the angled surface of the wedge.

EXAMPLE 46 can include, or can optionally be combined with the subject matter of any one of EXAMPLES 40-45, to optionally include the corresponding angled surface of the first insert forming an angle with a direction of movement of the first insert from about 45° to about 90°.

EXAMPLE 47 can include, or can optionally be combined with the subject matter of any one of EXAMPLES 40-46, to optionally include the corresponding angled surface of the first insert forming an angle with a direction of movement of the first insert from about 60° to about 88°.

EXAMPLE 48 can include, or can optionally be combined with the subject matter of any one of EXAMPLES 40-47, to optionally include the corresponding angled surface of the first insert forming an angle with a direction of movement of the first insert from about 65° to about 85°.

EXAMPLE 49 can include, or can optionally be combined with the subject matter of any one of EXAMPLES 40-48, to optionally include the corresponding angled surface of the first insert forming an angle with a direction of movement of the first insert of about 80°.

EXAMPLE 50 can include, or can optionally be combined with the subject matter of any one of EXAMPLES 39-49, to optionally include the wedge being slidably coupled to the first insert.

EXAMPLE 51 can include, or can optionally be combined with the subject matter of EXAMPLE 50, to optionally include the slidadble coupling of the wedge to the first insert being achieved with a sliding locking mechanism comprising a tongue on the wedge inserted into and slidable along a corresponding groove in the first insert.

EXAMPLE 52 can include, or can optionally be combined with the subject matter of EXAMPLE 51, to optionally include the slidable coupling of the wedge to the first insert being achieved with a sliding locking mechanism comprising a tongue on the first insert inserted into and slidable along a corresponding groove in the wedge.

EXAMPLE 53 can include, or can optionally be combined with, the subject matter of any one of EXAMPLES 20-52, to optionally include applying one or more thermal conditioning steps to the block.

EXAMPLE 54 can include, or can optionally be combined with, the subject matter of EXAMPLE 53, to optionally include each of the one or more thermal conditioning steps comprising holding the temperature of environmental surroundings around the block at a specified intermediate temperature for a specified duration of time.

EXAMPLE 55 can include, or can optionally be combined with, the subject matter of either one of EXAMPLES 53 or 54, to optionally include applying a plurality of thermal conditioning steps.

EXAMPLE 56 can include, or can optionally be combined with, the subject matter of either one of EXAMPLES 54 and 55, to optionally include the one or more thermal conditioning steps comprising one of: one (1) thermal conditioning step, two (2) thermal conditioning steps, three (3) thermal conditioning steps, four (4) thermal conditioning steps, five (5) thermal conditioning steps, six (6) thermal conditioning steps, seven (7) thermal conditioning steps, eight (8) thermal conditioning steps, nine (9) thermal conditioning steps, and ten (1) thermal conditioning steps.

EXAMPLE 57 can include, or can optionally be combined with, the subject matter of any one of EXAMPLES 54-56, to optionally include each intermediate temperature of each of the one or more thermal conditioning steps is less than the temperature of a preceding step and more than the temperature of a subsequent step.

EXAMPLE 58 can include, or can optionally be combined with, the subject matter of any one of EXAMPLES 53-56, to optionally include cooling the block after applying the one or more thermal conditioning steps.

EXAMPLE 59 can include, or can optionally be combined with, the subject matter of EXAMPLE 58, to optionally include the cooling of the block comprising air cooling the block.

The above Detailed Description is intended to be illustrative, and not restrictive. For example, the above-described examples (or one or more elements thereof) can be used in combination with each other. Other embodiments can be used, such as by one of ordinary skill in the art upon reviewing the above description. Also, various features or elements can be grouped together to streamline the disclosure. This should not be interpreted as intending that an unclaimed disclosed feature is essential to any claim. Rather, inventive subject matter can lie in less than all features of a particular disclosed embodiment. Thus, the following claims are hereby incorporated into the Detailed Description, with each claim standing on its own as a separate embodiment. The scope of the invention should be determined with reference to the appended claims, along with the full scope of equivalents to which such claims are entitled.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a molding system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented, at least in part. Some examples can include a computer-readable medium or machine-readable medium encoded with instructions operable to configure an electronic device to perform methods or method steps as described in the above examples. An implementation of such methods or method steps can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The Abstract is provided to comply with 37 C.F.R. §1.72(b), to allow the reader to quickly ascertain the nature of the technical disclosure. It is submitted with the understanding that it will not be used to interpret or limit the scope or meaning of the claims.

Although the invention has been described with reference to exemplary embodiments, workers skilled in the art will recognize that changes may be made in form and detail without departing from the spirit and scope of the invention.

1. A molding system for fabricating a part, the molding system comprising:
a first mold section defining a first mold cavity;
a first insert slidable to a plurality of positions relative to the first mold cavity to adjust a dimension of the mold cavity;
a second mold section to be disposed adjacent to the first mold section to at least partially enclose the first mold cavity;
a molding material conduit to be disposed in fluid communication with the first mold cavity; and
a positioning mechanism configured to move the first insert to the plurality of positions relative the first mold cavity;
wherein the mechanism comprises a wedge having an angled surface, and wherein the mechanism bears on a corresponding angled surface of the first insert, and wherein the molding system further comprises a sliding locking mechanism coupling the wedge to the first insert.

2. (canceled)

3. (canceled)

4. The molding system of claim 1, further comprising a sliding locking mechanism coupling the wedge to the first insert.

5. The molding system of claim 4, wherein the sliding locking mechanism comprises one of: a tongue on the wedge inserted into and slidable along a corresponding groove in the first insert, or a tongue on the first insert inserted into and slidable along a corresponding groove in the wedge.

6. The molding system of claim 1, further comprising a second mechanism configured to position the solidified molding material in the mold cavity.

7. The molding system of claim 6, wherein the second mechanism comprises one or more second inserts slidable within the second mold section.

8. The molding system of claim 1, wherein the first insert can be continuously moved to any position along a continuum between a rearward position and a forward position to adjust the dimension of the mold cavity.

9. The molding system of claim 8, wherein the positioning mechanism can be configured to move the first insert to any position along the continuum.

10. A method of fabricating a part, the method comprising:
disposing a first mold section adjacent to a second mold section to at least partially enclose a first mold cavity therebetween;
positioning a slidable insert at a first position within the first mold cavity to provide a first space having a predetermined first thickness at a front end of the mold cavity;
injecting a first molten molding material into the first space of the mold cavity;
allowing the first molten molding material to set to form a first layer;
moving the slidable insert to a second position within the mold cavity to provide a second space having a predetermined second thickness between the first layer and the front end of the mold cavity;
injecting a second molten molding material into the second space of the mold cavity; and
allowing the second molten molding material to set to form a second layer, the second layer being mechanically coupled to the first layer to form a part after the second molten molding material sets;
wherein the positioning the slidable insert at the first position and moving the slidable insert to the second position is performed by an insert positioning mechanism comprising a wedge having an angled surface, wherein the angled surface bears on a corresponding angled surface of the first insert, and the wedge is slidably coupled to the first insert.

11. The method of claim 10, wherein the second molten molding material is the same materials as the first molten molding material.

12. The method of claim 10, wherein the second layer is mechanically coupled and chemically coupled to the first layer to form the part after the second molten molding material sets.

13. The method of claim 10, further comprising:
moving the slidable insert to a third position within the mold cavity to provide a third space having a predetermined third thickness between the second layer and the front end of the mold cavity;
injecting a third molten molding material into the third space of the mold cavity; and
allowing the molten material to set to form a third layer, the third layer being mechanically coupled to the second layer after the third molten molding material sets, the first layer, second layer, and third layer forming the part.

14. The method of claim 10, further comprising expulsing the part from the mold cavity.

15. The method of claim 14, further comprising, after expulsing the part from the mold cavity, performing one or more thermal conditioning steps on the part.

16. (canceled)

17. The method of claim 10, wherein the wedge is slidably coupled to the first insert.

18. The method of claim 17, wherein the slidable coupling of the wedge to the first insert is achieved with a sliding locking mechanism comprises one of: a tongue on the wedge inserted into and slidable along a corresponding groove in the first insert, or a tongue on the first insert inserted into and slidable along a corresponding groove in the wedge.

19. The method of claim 10, wherein positioning the first insert comprises moving the first insert to any position along a continuum between a rearward position and a forward position to provide the first space having the predetermined first thickness.

20. The method of claim 10, wherein the predetermined first thickness can be changed.

21. The method of claim 14, wherein a plurality of thermal conditioning steps are performed on the part and each intermediate temperature of each of the thermal conditioning steps is less than a temperature of a preceding step and more than a temperature of a subsequent step.

22. The method of claim 21, further comprising cooling the block after applying the thermal conditioning steps.
